(19) United States
(12) Patent Application Publication
(10) Pub. No.: US 2026/0093389 A1
(43) Pub. Date: Apr. 2, 2026

(54) DEVICE ALIGNMENT BASED UPON AN ADJUSTMENT OF A POSITION

(71) Applicant: Lenovo (United States) Inc., Morrisville, NC (US)

(72) Inventors: Wenyu Du, Beijing (CN); Rod D. Waltermann, Rougemont, NC (US); Jung Hwan Hong, Cary, NC (US); Christopher Smith, Franklinton, NC (US)

(21) Appl. No.: 18/902,671

(22) Filed: Sep. 30, 2024

(51) Int. Cl. G06F 3/04847; G06F 1/16

(52) U.S. Cl. CPC G06F 3/04847; G06F 1/1694; G06F 2200/1637

(57) ABSTRACT

One embodiment provides a device, including: receiving an indication of an adjustment of a position of a display of at least one additional device paired with a display of an information handling device from a first position; presenting a first visual indicator on a display of the information handling device reflecting the first position of the at least one additional device when paired with the information handling device and a second visual indicator on the display of the at least one additional device reflecting the first position of the at least one additional device; receiving input for adjusting a position of at least one of the first visual indicator and the second visual indicator, wherein the input aligns the first visual indicator and the second visual indicator based upon the second position; and aligning, based upon the input, the display of the information handling device and the display of the at least one additional device.

### BACKGROUND

Multiple display device systems allow a user to view more information than previously permitted with a single display device system. Such systems allow a user to move between items with ease and potentially be more productive with their time. In an entertainment sense, a multiple display device configuration may permit a user to view an item of one display while following along with additional information on another. Many different devices may have associated displays or may communicate with displays, where the devices and/or displays can be paired or set to communicate with each other, thereby allowing the user to utilize these displays in conjunction with each other. Some devices may have different size displays, have displays with different characteristics, and/or the like. However, in multiple display device configurations, these displays can still be used in conjunction with one another even in view of any disparate characteristics across the displays.

### BRIEF SUMMARY

In summary, one aspect provides a method, including: receiving, at a device alignment system, an indication of an adjustment of a position of a display of at least one additional device paired with a display of an information handling device from a first position; presenting, utilizing a graphical user interface of the device alignment system, a first visual indicator on the display of the information handling device reflecting the first position of the at least one additional device when paired with the information handling device and a second visual indicator on the display of the at least one additional device reflecting the first position of the at least one additional device; receiving, from a user within the graphical user interface, input for adjusting a position of at least one of the first visual indicator and the second visual indicator, wherein the input aligns the first visual indicator and the second visual indicator based upon the second position; and aligning, utilizing the device alignment system and based upon the input, the display of the information handling device and the display of the at least one additional device.

Another aspect provides a system, the system including: an information handling device including a display; at least one additional device including a display; a processor; a memory device that stores instructions that, when executed by the processor, causes the system to: receive, at a device alignment system, an indication of an adjustment of a position of the display of the at least one additional device paired with the information handling device from a first position to a second position; present, utilizing a graphical user interface of the device alignment system, a first visual indicator on the display of the information handling device reflecting the first position of the at least one additional device when paired with the information handling device and a second visual indicator on the display of the at least one additional device reflecting the first position of the at least one additional device; receive, from a user within the graphical user interface, input adjusting a position of at least one of the first visual indicator and the second visual indicator, wherein the input aligns the first visual indicator and the second visual indicator based upon the second position; and align, utilizing the device alignment system and based upon the input, the display of the information handling device and the display of the at least one additional device.

A further aspect provides a product, the product including: a computer-readable storage device the stores executable code that, when executed by a processor, causes the product to: receive, at a device alignment system, an indication of an adjustment of a position of a display of at least one additional device paired with a display of an information handling device from a first position to a second position; present, utilizing a graphical user interface of the device alignment system, a first visual indicator on the display of the information handling device reflecting the first position of the at least one additional device when paired with the information handling device and a second visual indicator on the display of the at least one additional device reflecting the first position of the at least one additional device; receive, from a user within the graphical user interface, input adjusting a position of at least one of the first visual indicator and the second visual indicator, wherein the input aligns the first visual indicator and the second visual indicator based upon the second position; and align, utilizing the device alignment system and based upon the input, the display of the information handling device and the display of the at least one additional device.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for aligning a display of an information handling device and the display of at least one additional device by use of a device alignment system.

FIG. 4 provides an example illustration of aligning displays by use of a device alignment system after adjusting a planar position of at least one device.

FIG. 5 provides an example illustration of aligning displays by use of a device alignment system after adjusting an orientation of at least one device.

FIG. 6 provides an example illustration of aligning displays by use of a device alignment system after adjusting a relative location of at least one device.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Even though displays having disparate characteristics can be used in conjunction with one another, the user may still want to align the displays to work the most seamlessly. However, the connection and aligning of displays paired together requires the use of traditional methods that may become time consuming when the ordering of the display is not turning out the way a user intended. Therefore, what can be initially seen as productive may become quickly frustrating.

Conventional display alignments for systems containing an information handling device and at least one additional device include manually adjusting screen alignment settings via display settings of the information handling device. Tedious input for aligning a display of an additional device paired to the information handling device is performed an in attempt to align displays. Such a traditional method of aligning is a manual process, is non-intuitive, and often interrupts workflow. Concentration on aligning screens can detour thought, distract a user for an extended period of time, and become frustrating, and may even lead to a reluctance in utilizing the system when a system is not aligning as intended. Therefore, what is needed is a system and method that permits simple aligning of displays of one or more additional devices paired to an information handling device that does not disrupt workflow and may be accomplished with ease.

Accordingly, the described system provides a method for aligning a display of an information handling device and a display of at least one additional device that is paired to the information handling device by use of a device alignment system. A device alignment system may receive an indication of an adjustment of a position of the at least one additional device that is paired with an information handling device from a first position. In other words, the device alignment system may identify when an additional device in a first position moves to a second position. This position adjustment is based upon a relative position of the at least one additional device with respect to the information handling device. Therefore, the device alignment system may receive an indication when a position of the at least one additional device is changed.

The device alignment system may then utilize a graphical user interface to present visual indicators on the display of the information handling device and the display of the at least one additional device paired to the information handling device. These visual indicators may indicate a first position of the at least one additional device in relation to the information handling device. The display of the information handling device presenting the graphical user interface may include a first visual indicator identifying the first position of the at least one additional device, and the display of the at least one additional device presenting the graphical user interface may include a second visual indicator identifying the first position of the device in relation to a location of the information handling device. In other words, the location of these visual indicators on the displays may be associated with the first position of the additional device with respect to the information handling device.

Thus, because a position of the devices has been adjusted, the visual indicators may be misaligned across the displays. In other words, the first position of the first visual indicator and the second visual indicator may identify an alignment relationship between devices prior to receiving an indication of an adjustment of position. Then, utilizing the graphical user interface of the device alignment system, a user may provide input for adjusting a position of at least one visual indicator in an attempt to align the visual indicators based upon the second position of the displays.

Aligning the first visual indicator present on the display of the information handling device with a second visual indicator present on the display of the at least one additional device may promote a smooth and consistent transition between device displays. An information handling device that is paired with a secondary device may be subject to display inconsistencies (e.g., mouse jumping, incorrect display orientation, inaccurate selections, etc.) while moving between screens. The device alignment system may provide a system and method for easy display alignment based on the use of visual indicators present on a graphical user interface of the system. Then, when the first visual indicator present on the display of the information handling device and the second visual indicator present on the display of the at least one additional device are aligned at a second position by user input, the device alignment system may align the displays for use without inconsistencies. Such a system and method provide an improvement over traditional device alignment methods that require accessing system settings and providing tedious input when attempting to achieve a smooth transition of visual elements between devices.

The illustrated example embodiments will be best understood by reference to the figures. The following description is intended only by way of example, and simply illustrates certain example embodiments.

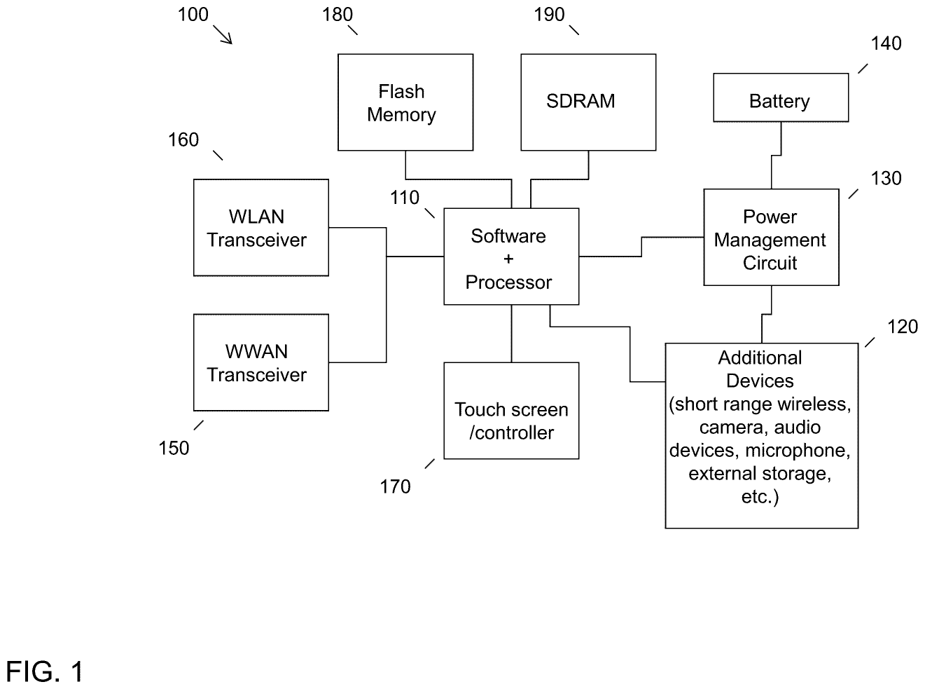

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

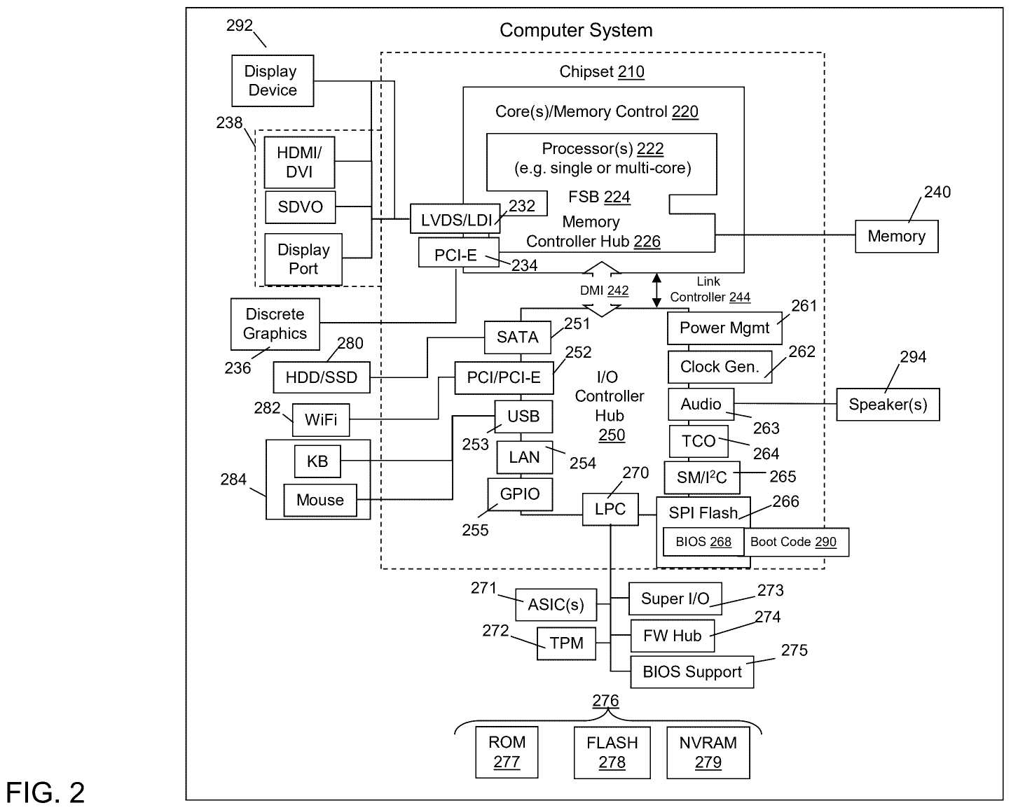

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may include devices that may be paired with each other. For example, the circuitry outlined in FIG. 1 may be implemented in a tablet or smart phone embodiment, whereas the circuitry outlined in FIG. 2 may be implemented in a personal computer embodiment.

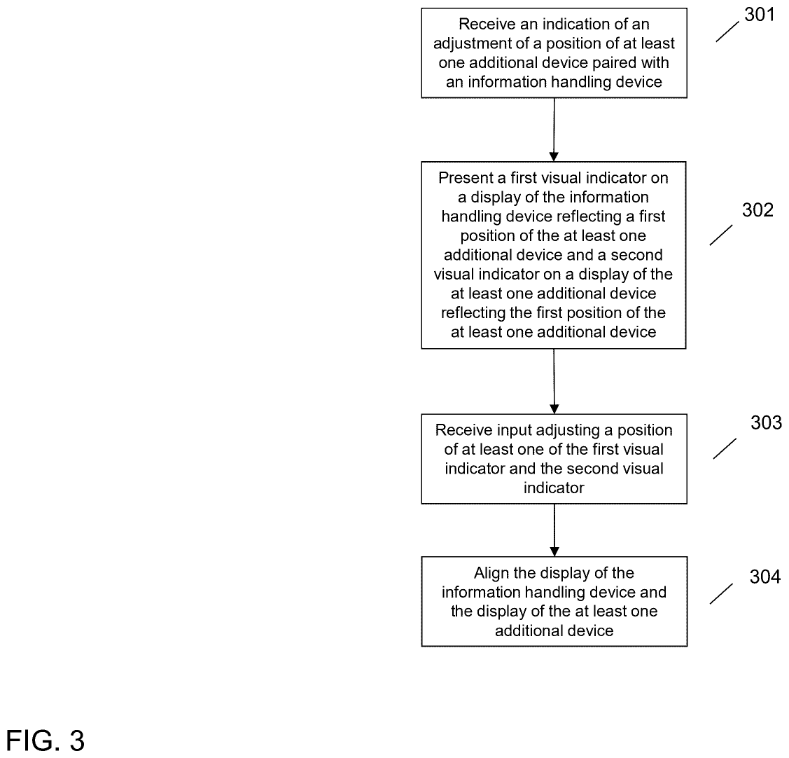

FIG. 3 illustrates an example method for aligning displays of a paired information handling device and at least one additional device by use of a device alignment system. The method may be implemented on a system which includes a processor, memory device, output devices (e.g., display device, etc.), input devices (e.g., keyboard, touch screen, mouse, microphones, sensors, etc.), and/or other components, for example, those discussed in connection with FIG. 1 and/or FIG. 2. While the system may include known hardware and software components and/or hardware and software components developed in the future, the system itself is specifically programmed to perform the functions as described herein to adjust an alignment position between an information handling device and at least one additional device by use of a graphical user interface. Additionally, the device alignment system includes modules and features that are unique to the described system.

Activation of the device alignment system may be a manual activation of the screen extension system and/or an automatic activation of the device alignment system. The automatic activation of the device alignment system may be based upon the detection of a trigger event indicating that the system should be activated.

The device alignment system may be made of multiple systems or modules that communicate together to make up the device alignment system or may be a single system. The device alignment system may be a standalone system, may be accessible through other computing devices, and/or a combination thereof. For example, the device alignment system may be a standalone system that can be accessed by a user and/or may be or provide an application that is accessible by a user on another computing device. The device alignment system may be accessible using any type of computing device, for example, personal computer, laptop computer, smartphone, tablet, smartwatch, head-mounted display, smart television or other smart appliance, augmented reality device, virtual reality device, and/or the like.

Thus, the device alignment system may be a standalone system, may be accessible through other computing devices, and/or a combination thereof. For example, the device alignment system may be a standalone system accessed by a user and/or may be provided as an application that is accessible by a user on a computing device. The device alignment system may be accessible using any type of computing device, for example, a personal computer, laptop computer, smartphone, tablet, smartwatch, smart television, smart appliance, augmented reality device, virtual reality device, and/or the like. The device alignment system may be accessible locally using a computing device where the device alignment system is installed and/or may be accessible remotely through another computing device. However, the device alignment system may be located and operated on an information handling device to perform the described steps.

The device alignment system may utilize one or more artificial intelligence models in presenting a graphical user interface to a user across paired devices, receiving an indication of an adjustment of a position of devices, aligning the display of the information handling device and the display of the at least one additional device, and/or the like. Artificial intelligence models may also be used for steps within a step. For example, a model could be utilized to receive and analyze sensor information that indicates of an adjustment of a position and/or detecting a movement of the at least one additional device. As another example, a model could be utilized to align the display of the information handling device and the display of the at least one additional device by calculating a relative position of the at least one additional device with respect to the information handling device, and/or the like. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the query response refinement and transfer system or may be a model that is created from scratch. Since the query response refinement and transfer system is used in conjunction with creating a refined query and transferring the refined query to another query response system, some models that may be utilized by the system are image analysis models, audio analysis models, other analysis models, entity identification models, similarity identification models, language models, large language models, filtering models, classification models, and/or the like. The model may be trained using one or more training datasets. Additionally, as the model is deployed, it may receive feedback to become more accurate over time. The feedback may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model ingests this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. The feedback, either from incorrect predictions or correct predictions, can also be stored in a data storage location for subsequent training of the model. Training the model may be performed in one of any number of ways including, but not limited to, supervised learning, unsupervised learning, semi-supervised learning, training/validation/testing learning, and/or the like.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The device alignment system may include different components for carrying out different functions of the system, including different steps to be performed. These components may be hardware components or software components. Some hardware components may include sensors (e.g., image capture devices, proximity sensors, microphones, accelerometers, activity trackers, health metric sensors, etc.) that can be used to receive an indication of an adjustment of a position of a display of at least one additional device paired with a display of an information handling device from a first position, presenting a first visual indicator on a display and presenting a second visual indicator on a display, receiving input for adjusting a position of at least one of the first visual indicator and the second visual indicator, and aligning the display of the information handling device and the display of the at least one additional device, and/or the like. Other input devices may be utilized to assist with the described system and method, for example, mechanical input modalities (e.g., keyboard, mouse, etc.), touch input devices, gesture input devices, electromyography input devices, audio input devices, and/or the like. Other hardware components may be utilized to provide output from the device alignment system, for example, displays, monitors, audio output devices, haptic output devices, and/or the like.

One software component may include a user profile which may be unique to a user and may assist in aligning displays. For example, the user profile may include user preferences such as the shape or type of visual indicators that are presented, how the displays should be aligned, the types of inputs that the user can utilize, and/or the like. The user may manually input this data into the profile or the information may be populated by the system as the system learns about the user over time. For example, the system may utilize an artificial intelligence model to learn about the user, make correlations between information received from sensors and other inputs and alignments of displays, and/or the like. This information can be populated within the user profile for use by the system during subsequent display alignment sessions. The user profile may also include other information about the user that seems to influence device alignments, for example, the devices being utilized, a location of a user during device alignments, and/or the like.

At 301, a system may receive an indication of an adjustment of a position of a display of at least one additional device that is paired with an information handling device. The information handling device and the at least one secondary device may be paired devices that work in combination with one another or otherwise communicate with each. Additionally, the devices may be paired so as to permit movement across their associated displays. Accordingly, the display of the information handling device and the display of the secondary device establishes a multiple display system. It should be noted that while two devices and/or displays are discussed herein, an information handling device (referred to as the base device for ease of readability) and a secondary device (referred to as the other device for ease of readability), more than two devices and/or displays can be paired and in communication with each other. Thus, the disclosure is not limited to only two devices as the system can be utilized to work with more than two devices and/or more than two displays.

When receiving an indication of an adjustment of a position, the device alignment system may detect a movement of a relative position of a display of at least one of the information handling device and a display of the at least one additional device that are paired together. This may also be referred to as detecting movement of the information handling device or the additional device. However, it should be noted that it is the displays of the two devices of which the system is identifying whether there is a movement. Thus, where it is stated that the movement of the information handling device and the at least one additional device or movement of the device is detected, it is really the movement of the display(s) that is detected.

Detection of a movement of the additional device may indicate a repositioning the additional device at a new, or second location, relative to the position of the information handling device. In other words, the additional device, and specifically, the display of the additional device, may be physically moved from a first position to a second position. Alternatively, or additionally, the information handling device, and specifically, the display of the information handling device, may be moved from a first position to a second position. Thus, detection of the adjustment of the position includes detecting that the additional device display and the information handling device display are in a different position with respect to each other. Movement of the additional device with respect to the position of the information handing device may be referenced herein. However, this is intended as non-limiting, as a situation may arise when it is the information handling device or display thereof that moves in relation to the additional device or display thereof.

Receiving an indication and the detection of a movement of the device(s) may be determined based upon at least one of a variety of movement detection types. A detected movement may include detecting a change in orientation of the at least one additional device. An orientation may identify a presentation-type of a display, for example, a portrait orientation and/or a landscape orientation. A device may permit utilization in both orientations, and may further permit that transitioning between device orientations. This transitioning between an orientation of a display from a portrait orientation to a landscape orientation, and/or vice versa, may act as a detected movement of the device, which will result in the device alignment system receiving an indication of an adjustment position.

Additionally, and/or alternatively, the device alignment system may receive an indication of an adjustment of a position of the device from first position to a second position based upon a change in planar direction of the device. A device may be repositioned around the information handling device for a plurality of reasons, for example, pairing an additional device to the information handling device, adjusting a position of the information handling device, and/or the like, which may result in detecting a movement of a device in a planar direction. A detected movement in a planar direction may include detecting when an additional device is adjusted in a horizontal direction and/or vertical direction based upon a current position of an information handling device with which the additional device is paired. A detection of a movement of at least one additional device in a planar direction may include, for example, detecting that a device position along the right edge of a display of an information handling device has been moved up or down along the right edge. As another example, a detection of a movement of a device in a planar direction may include detecting that a device positioned along a top edge of a display of an information handling device has been moved to the left or right along the top edge of the display.

Additionally, and/or alternatively, the device alignment system may receive an indication of an adjustment of position upon detecting a movement of the device based upon a change in a relative location of the device with respect to the information handling device. A relative location of the device may indicate where and/or how the display of the additional device is positioned with respect to the position of the display of the information handling device. For example, a relative position of the at least one additional device display may be located about a right edge of the information handling device display. Then, for example, the additional device display may be moved to a second position located about a top edge of the information handling device display. Therefore, in this example, the relative position of the additional device display moves from a first position at the right edge of the information handling device display to a second position along a top edge of the information handling device display. Thus, the relative position may indicate a horizontal and vertical position of the additional device display with respect to the information handling device display instead of just one of the positions as with the planar direction.

The device alignment system may detect a movement of the device display with any change in position no matter how large of a change, for example, a device display adjusted an inch may result in the device alignment system receiving an indication of an adjustment in position. Additionally, and/or alternatively, the device alignment system may receive an indication of an adjustment of position upon detection of a movement of the device display that exceeds a predetermined threshold level of movement. For example, if a predetermined threshold level of movement is established to be two-inches of movement, any adjustment of position under two-inches may not result in receipt of an indication. However, as a continued example, if a detected movement of an additional device display exceeds the predetermined threshold level of movement of two-inches, the device alignment system may receive an indication of an adjustment of position of the device display paired with an information handling device from a first position. Any predetermined thresholds may be default values, configured by the user, learned by the system overtime, identified using an artificial intelligence model, and/or the like.

The indication of an adjustment of a position may be received subsequent to an adjustment of a device display from a first position to a second position. This movement is achieved by the device alignment system detecting a movement in line with a movement type as also described previously. An additional device display present at a second position, and/or a position different than the first position, may then cause alignment issues between the paired device displays, because the displays are aligned based upon when the additional device display was present at the first position. In order to correct these alignment issues, the device alignment system may utilize a graphical user interface that may present a first visual indicator on a display of the information handling device reflecting the first position of the at least one additional device when paired with the information handling device, and a second visual indicator on a display of the at least one additional device reflecting the first position of the at least one additional device at 302.

The graphical user interface of the device alignment system may span across the displays of each device paired, for example, the information handling device and the at least one additional device. Additionally, and/or alternatively, the presenting the graphical user interface may include presenting a blurred overlay across an input area on the display of the information handling device and/or the display of the additional device and presenting the graphical user interface over the blurred overlay. A blurred overlay may lock, and/or suspend, user influence with the information present on a display of the information handling device and the at least one additional device that are paired together. In other words, when utilizing the graphical user interface of the device alignment system, information present on a display of a paired device may not be interacted with through the use of the overlay. While a blurred overlay is discussed, the overlay may be any type of overlay, for example, a transparent overlay, a digital textured overlay, a colored overlay, an animated overlay, and/or the like.

Additionally, the first visual indicator presented on the information handling device display may indicate an alignment point between the two displays when the displays were present at the first position. Prior to detecting a movement of the at least one additional device and receiving an indication of an adjustment, the first visual indicator and the second visual indicator were aligned. In other words, the first visual indictor and the second visual indicator, present at an edge of their associated displays, were in line with one another. This alignment of visual indicators ensured a smooth and consistent transition between displays of the paired devices and movements of virtual objects therebetween. However, when presenting, responsive to receiving an indication of an adjustment of a position at 301, a first visual indicator on the information handling device display and a second visual indicator on the additional device display may no longer be aligned due to the fact that the at least one additional device display has been moved to the second position. This misalignment of visual indicator indicates an alignment issue between devices.

After presenting the visual indicator of each associated device paired on a graphical user interface, a user may determine if a position of at least one visual indicator requires adjusting. In determining the position of at least one visual indicator requires adjusting, a user may view the visual indicators present on each display and determine if the visual indicators are aligned across an edge of the display of the information handing device and an edge of the display of the at least one additional device. When it is determined that the first visual indicator aligns with the second visual indicator, a user will not provide input for adjusting a visual indicator. However, when it is determined that the first visual indicator and the second visual indicator are not aligned, the device alignment system may receive input adjusting a position of at least one of the first visual indicator and the second visual indicator 303.

Input for adjusting a position of at least one of the first visual indicator and the second indicator may be received at the graphical user interface of the device alignment system. Input at the graphical user interface may include input that aligns the first visual indicator and the second visual indicator based upon the second position of the at least one additional device. Aligning the position of the first visual indicator present on the display of the information handling and/or the position of the second visual indicator preset on the display of the at least one additional device may assist in correcting the inconsistencies present between the displays of the devices after a display has been moved. While the input can be received at either the first visual indicator, the second visual indicator, or both indicators, the description will refer to receiving input at the second visual indicator. However, this is simply for ease of readability and is not intended to limit the description to only provision of input at the second indicator.

Input for adjusting a position may be provided by use of any human-machine interfaces, for example, mouse, keyboard, trackpads, touchscreen devices, stylus, and/or the like. Input for adjusting a position of the second visual indicator may include utilizing a drag-and-drop method. The drag-and-drop input may include utilizing a technique where a user selects and holds a visual indicator, dragging the visual indicator to another position on a display of the device while holding the visual indicator and dropping, and/or releasing the selection of, the visual indicator at the desired location on the display. Thus, the user can drag the visual indicator until it is aligned with the visual indicator of the other display. The user may also want the alignment to misaligned but changed. Thus, the user could change the position of the visual indicator until it matches what is desired by the user, even if it means that it does not align with the other visual indicator.

Though such a drag-and-drop input method may be implemented and described further herein, an input for adjusting a position of the at least one of the first visual indicator and the second visual indicator is not limited to this technique. For example, a traditional selection method for adjusting by selecting a visual indicator, and thereafter, selecting a new position of the indicator on the display of an accompanying device may be utilized. Additionally, for example, a cut-and-paste technique may be utilized. The input methods described herein are intended as non-limiting examples for receiving input for adjusting a position of at least one of the first visual indicator and the second visual indicator, and other techniques are contemplated and possible.

Additional to receiving an input for adjusting a position of the visual indicator, the device alignment system may receive an indication from the user that the input adjusting the position of the visual indicator is complete. Upon completion of an input for adjusting a position, the user may notify the device alignment system that the position of one or more visual indicators is complete, and then, the device alignment system may move forward with aligning the display of the information handling device and the display of the at least one additional device. Receiving an indication from a user that the input for adjusting the position of the visual indicator is complete may include, for example, selecting a completion/submit icon present in the graphical user interface, providing input at an “ENTER” key present on a keyboard, closing out of the graphical user interface, providing a particular audible phrase, performing a particular gesture, and/or the like. Additionally, and/or alternatively, upon completion of a user input for adjusting a position of the visual indicator, the device alignment system may automatically recognize the completion of input.

The device alignment system may then align the display of the information handling device and the display of the at least one additional device at 304 based upon the input received by the system. The alignment of the displays may be automatic in response to determining the alignment of the first visual indicator and the second visual indicator. Alternatively, or additionally, the alignment of the displays may occur after the user has providing an input that the alignment should be performed.

In aligning the displays, the device alignment system may calculate a relative position of the additional device display with respect to the information handling device display based upon the input, where the aligning is based upon the relative positions. The received user input may determine the parameters for calculating a relative position of the additional device display. For example, when the additional device display having a second visual indicator at a second position aligns with a first visual indicator, calculating the relative position may result in smooth and consistent transitions of virtual objects between paired device displays. However, for example, when the additional device display having a second visual indicator at a second position fails to align with the first visual indicator, calculating the relative position may result in inconsistent transitions between paired devices.

Additionally, and/or alternatively, when receiving input for adjusting, and thereafter, aligning the display of the information handling device and the display of the at least one additional device, the device alignment system may utilize an uncertainty calculation, and/or proximity calculation, that may account for any minor alignment issues that are intended as being aligned. In other words, the device alignment system in combination with an artificial intelligence model or other calculation, may determine when to account and/or overcome slight misalignments when the visual indicators are intended to be aligned.

Additionally, and/or alternatively, when aligning the display of the information handling device and the display of the at least one additional device, the device alignment system may calculate a pixel offset based upon a calculated relative position of the at least one additional device. Calculating a pixel offset may account for any additional pixels present on a display of the information handling device and/or the display of the at least one additional device that falls outside of the overlap between the paired display of the information handling device and/or the display of the at least one additional device. In other words, the displays may be of disparate sizes. Calculating the pixel offset accounts for the disparate sizes while still ensuring that the displays are aligned. Thus, calculating the pixel offset may determine where smooth transitions between displays are possible based upon the sizes of the displays. For example, if Display A has a first visual indicator about 6″ from the top of a display and Display B has a second visual indicator about 2.5″ from the top of a display (based upon the relative sizes of the displays), the top of Display B is about 3.5″from the top Display A. Therefore, the dots-per-inch (DPI), and/or pixels, present can be utilized to determine the most acceptable ratio to ensure accuracy when moving between the displays containing different parameters.

Upon aligning the display of the additional device with the display of the information handling device, and/or aligning the display of the information handling device with the display of the additional device, the device alignment system may present an indication to the user of a successful realignment of the displays. Such an indication may indicate to a user that the input for adjusting provided resulted in a realignment as the user intended. Additionally, and/or alternatively, the device alignment system may provide an indication indicating a realignment was unsuccessful and inconsistencies across the displays of paired devices may remain.

Described herein are examples of situations of varying indications of an adjustment of a position of a display of at least one additional device paired with an information handling device. Example representations of a first position of the at least one additional device display, a movement detected by the device alignment system, and a received input for aligning a position of at least one of the visual indicator and the second indicator are provided. These are intended as non-limiting examples.

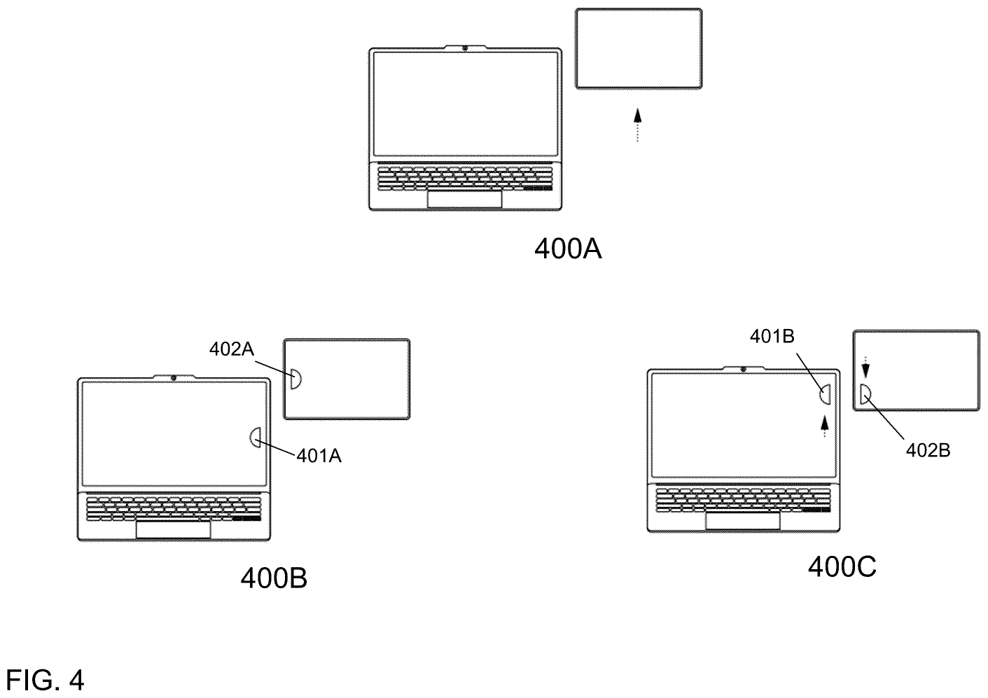

FIG. 4. provides an example illustration of aligning displays by use of a device alignment system after adjusting a planar position of at least one device display. As can be seen in FIG. 4, illustration 400A includes an additional device display in a landscape orientation present along a right edge of the information handling device display. This is the first position of the additional device display with respect to the information handling device display. System 400A illustrates a vertical, and/or vertical planar movement, along the right edge of the information handling device. In other words, the second position of the additional device display will be moved towards the top edge of the information handling device display.

Moving to illustration 400B, the first visual indicator 401A on the information handling device display reflects the position of the additional device as it was present at the prior first position, and the second visual indicator 402A on the display of the additional device reflects the first position, as well. As can be seen in 400B, the first visual indicator 401A and the second visual indicator 402A are not aligned. Then, moving to illustration 400C, the first visual indicator 401B and the second visual indicator 402B can be seen as being adjusted to a second position. 401B receives input to move upwards to align, whereas 402B receives input to move downwards to align. The second position of the additional device warrants this adjusting of the first visual indicator 401B and the second indicator 402B to ascertain smooth and consistent movement between the displays of the paired devices. The system would then utilize this input to align the displays.

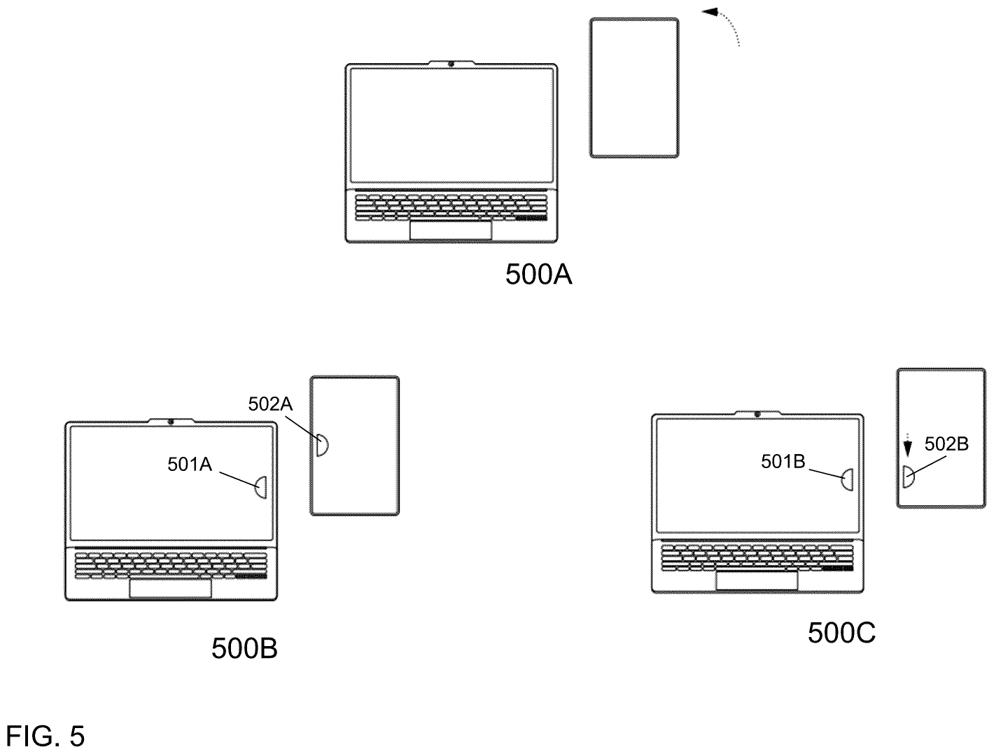

FIG. 5 provides an example illustration of aligning displays by use of a device alignment system after adjusting an orientation of at least one device. As can be seen in FIG. 5, illustration 500A includes an information handling device and an additional device present about a right edge of the information handling device having a portrait orientation. Illustration 500A indicates an orientation change of the additional device from a landscape orientation (as is present in 400A) to a portrait orientation. This is identified by the arrow present in 500A. Therefore, the detected movement of the device is the transition from a landscape orientation to a portrait orientation.

500B then illustrates a system where a first visual indicator 501A reflects the position of the additional device as it was present at the first position, and the second visual indicator 502A on the display of the additional device reflects the first position of the additional device prior to the orientation change. Then, moving to illustration 500C, the first visual indicator 501B can be seen as remaining in a same position as the second visual indicator 502B is adjusted in a downward direction to align with the first visual indicator 501B. As can be envisioned, when rotating an additional device from a landscape orientation to a portrait orientation, a visual indicator position about a center of an edge of a device with a portrait orientation will be greater, and/or higher, than that of a visual indicator present at a center of an edge of a device having a landscape orientation. Therefore, the input for adjusting a position is performed at the second visual indicator 502B to account for the change in parameter, and/or edge, size, as a result of changing an orientation-type.

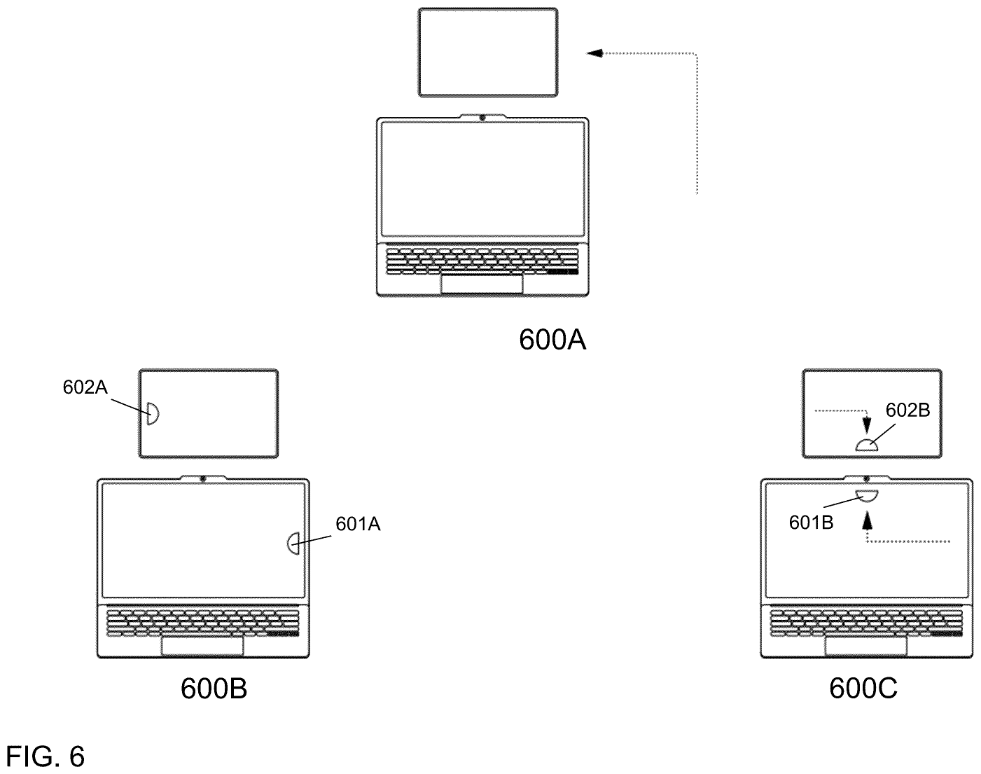

FIG. 6 provides an example illustration of aligning displays by use of a device alignment system after adjusting a relative location of at least one device. As can be seen in FIG. 6, illustration 600A includes an information handling device and an additional device present about a top edge of the information handling device having a landscape orientation. System 600A indicates a relative position change of the additional device from landscape orientation present about a right edge of the information handing device (as is present in 400A) to position about the top edge of the information handling device having a landscape orientation. There is no change in orientation of the of the device in this system, only a change in the relative position.

600B then illustrates the first visual indicator 601A reflecting the position of the additional device as it was present at the first position, and the second visual indicator 602A on the display of the additional device reflecting the first position of the additional device prior to the relative position change. The first visual indicator 601A and the second visual indicator 602A are clearly misaligned in 600B. Illustration 600C indicates the received user input at the first visual indicator 601B on the display of the information handling and the second visual indicator 602B on the display of the additional device. Since a relative position change to a second position along a new edge of the device is present, the first visual indicator 601B must be positioned about a top edge of the display of the information handling device from the right edge 601A, and the second visual indicator 602B must be positioned about the bottom edge of the display of the additional device from the left edge 602A. Alignment of the first visual indicator 601B and the second visual indicator 602B permits movement between the displays at a top edge of the display of information handling device and a bottom edge of the display of the additional device.

The various embodiments described herein provide an improvement over traditional method for aligning the display of an information handling device and the display of at least one additional device. Rather than requiring a user to access system settings and/or making manual changes utilizing traditional methods, the described system and method provides a device alignment system that may permit easy alignment by use of a graphical user interface. A device alignment system may receive an indication of an adjusted position of a device based upon a detected movement of an additional device in relation to an information handling device, and thereafter, permit simple visual indicator adjustments to align displays of an information handling device and at least one additional device paired to the information handling device. This is an improvement over traditional device alignment methods that conventionally require tedious input and/or result in inconsistencies across displays.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system. ” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more”unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at a device alignment system, an indication of an adjustment of a position of a display of at least one additional device paired with a display of an information handling device from a first position;
presenting, utilizing a graphical user interface of the device alignment system, a first visual indicator on the display of the information handling device reflecting the first position of the at least one additional device when paired with the information handling device and a second visual indicator on the display of the at least one additional device reflecting the first position of the at least one additional device;
receiving, from a user within the graphical user interface, input for adjusting a position of at least one of the first visual indicator and the second visual indicator, wherein the input aligns the first visual indicator and the second visual indicator based upon the second position; and
aligning, utilizing the device alignment system and based upon the input, the display of the information handling device and the display of the at least one additional device.

2. The method of claim 1, wherein the receiving the indication comprises detecting a movement of the at least one additional device.

3. The method of claim 2, wherein the detecting a movement comprises detecting at least one of: a change in an orientation of the at least one additional device, a change in a planar direction of the at least one additional device, and a change in a relative location of the at least one additional device with respect to the information handling device.

4. The method of claim 1, comprising presenting, responsive to aligning the display, an indication of the user of a successful realignment of the display of the information handling device and the display of the at least one additional device.

5. The method of claim 1, wherein the aligning comprises calculating a relative position of the at least one additional device with respect to the information handling device based upon the input and wherein the aligning is based upon the relative position.

6. The method of claim 5, wherein the aligning comprises calculating a pixel offset based upon the relative position.

7. The method of claim 1, wherein the receiving the input comprises receiving a drag-and-drop input on the at least one of the first visual indicator and the second visual indicator.

8. The method of claim 1, wherein the receiving the input comprises receiving an indication from the user that the input adjusting the position of at least one of the first visual indicator and the second visual indicator is complete.

9. The method of claim 1, wherein the aligning is automatically performed upon detecting alignment of the first visual indicator and the second visual indicator.

10. The method of claim 1, wherein the presenting comprises presenting a blurred overlay across an input area on the display of the information handling device and presenting the graphical user interface over the blurred overlay.

11. A system, the system comprising:
an information handling device comprising a display;
at least one additional device comprising a display;
a processor;
a memory device that stores instructions that, when executed by the processor, causes the system to:
receive, at a device alignment system, an indication of an adjustment of a position of the display of the at least one additional device paired with the information handling device from a first position to a second position;
present, utilizing a graphical user interface of the device alignment system, a first visual indicator on the display of the information handling device reflecting the first position of the at least one additional device when paired with the information handling device and a second visual indicator on the display of the at least one additional device reflecting the first position of the at least one additional device;
receive, from a user within the graphical user interface, input adjusting a position of at least one of the first visual indicator and the second visual indicator, wherein the input aligns the first visual indicator and the second visual indicator based upon the second position; and
align, utilizing the device alignment system and based upon the input, the display of the information handling device and the display of the at least one additional device.

12. The system of claim 11, wherein the receiving the indication comprise detecting a movement of the at least one additional device.

13. The system of claim 12, wherein the detecting a movement comprises detecting at least one of: a change in orientation of the at least one device, a change in a planar direction of the at least one additional device, and a change in a relative location of the at least one additional device with respect to the information handling device.

14. The system of claim 11, comprising presenting, responsive to aligning the display, an indication to the user of a successful realignment of the display of the information handling device and the display of the at least one additional device.

15. The system of claim 11, wherein the aligning comprises calculating a relative position of the at least one additional device with respect to the information handling device based upon the input and wherein the aligning is based upon the relative position.

16. The system of claim 15, wherein the aligning comprises calculating a pixel offset based upon the relative position.

17. The system of claim 11, wherein the receiving the input comprises receiving a drag-and-drop input on the at least one of the first visual indicator and the second visual indicator.

18. The system of claim 11, wherein the receiving input comprises receiving an indication from the user that the input adjusting the position of at least one of the first visual indicator and the second visual indicator is complete.

19. The system of claim 11, wherein the aligning is automatically performed upon detecting alignment of the first visual indicator and the second visual indicator.

20. A product, the product comprising:
a computer-readable storage device the stores executable code that, when executed by a processor, causes the product to:
receive, at a device alignment system, an indication of an adjustment of a position of a display of at least one additional device paired with a display of an information handling device from a first position to a second position;
present, utilizing a graphical user interface of the device alignment system, a first visual indicator on the display of the information handling device reflecting the first position of the at least one additional device when paired with the information handling device and a second visual indicator on the display of the at least one additional device reflecting the first position of the at least one additional device;
receive, from a user within the graphical user interface, input adjusting a position of at least one of the first visual indicator and the second visual indicator, wherein the input aligns the first visual indicator and the second visual indicator based upon the second position; and
align, utilizing the device alignment system and based upon the input, the display of the information handling device and the display of the at least one additional device.
